(19) United States
(12) Patent Application Publication
(10) Pub. No.: US 2006/0059988 A1
(43) Pub. Date: Mar. 23, 2006

(54) Magnetofluidic accelerometer with non-magnetic film on drive magnets

(75) Inventor: Alexander G. Pristup, Novosibirsk (RU)

Correspondence Address: BARDMESSER LAW GROUP, P.C., 910 17TH STREET, N.W., SUITE 800, WASHINGTON, DC, 20006, US

(73) Assignee: Innalabs Technologies, Inc., Dulles, VA (US)

(21) Appl. No.: 11/006,567

(22) Filed: Dec. 8, 2004

Related U.S. Application Data
(63) Continuation-in-part of application No. 10/980,791, filed on Nov. 4, 2004.
(60) Provisional application No. 60/616,849, filed on Oct. 8, 2004.
(60) Provisional application No. 60/612,227, filed on Sep. 23, 2004.
(60) Provisional application No. 60/613,723, filed on Sep. 29, 2004.
(60) Provisional application No. 60/614,415, filed on Sep. 30, 2004.

(51) Int. Cl. G01P 15/11

(52) U.S. Cl. 73/514.05; 73/510; 73/514.02; 324/260

(57) ABSTRACT

A sensor includes an inertial body; a plurality of sources of magnetic field located generally surrounding the inertial body; magnetic fluid between the sources and the inertial body; and a non-magnetic coating on surfaces of the sources facing the magnetic fluid. Displacement of the inertial body is indicative of acceleration. The acceleration can include linear acceleration and angular acceleration. The angular acceleration can include three components of acceleration about three orthogonal axes. The sources include permanent magnets, or electromagnets, or both. A plurality of sensing coils detect changes in magnetic field within the magnetic fluid due to the displacement of the inertial body. The non-magnetic coating can also cover the sensing coils. A housing encloses the inertial body and the magnetic fluid. The magnetic fluid can use kerosene, water or oil as the carrier liquid. The magnetic fluid is a colloidal suspension. The non-magnetic coating can use Teflon (tetrofluoroethylene), PET (polyethyleneteraphthalate), a polyimide, a polymer or a resin.

### CROSS-REFERENCE TO RELATED APPLICATIONS

This application is a continuation-in-part of U.S. application Ser. No. 10/980,791, entitled MAGNETOFLUIDIC ACCELEROMETER WITH ACTIVE SUSPENSION, filed Nov. 4, 2004.

This application claims the benefit of U.S. Provisional Patent Application No. 60/616,849, entitled MAGNETOFLUIDIC ACCELEROMETER AND USE OF MAGNETOFLUIDICS FOR OPTICAL COMPONENT JITTER COMPENSATION, Inventors: SUPRUN et al., filed: Oct. 8, 2004; U.S. Provisional Patent Application No. 60/614,415, entitled METHOD OF CALCULATING LINEAR AND ANGULAR ACCELERATION IN A MAGNETOFLUIDIC ACCELEROMETER WITH AN INERTIAL BODY, Inventors: ROMANOV et al., filed: Sep. 30, 2004; U.S. Provisional Patent Application No. 60/613,723, entitled IMPROVED ACCELEROMETER USING MAGNETOFLUIDIC EFFECT, Inventors: SIMONENKO et al., filed: Sep. 29, 2004; and U.S. Provisional Patent Application No. 60/612,227, entitled METHOD OF SUPPRESSION OF ZERO BIAS DRIFT IN ACCELERATION SENSOR, Inventor: Yuri I. ROMANOV, filed: Sep. 23, 2004; which are all incorporated by reference herein in their entirety.

This application is related to U.S. patent application Ser. No. 10/836,624, filed May 3, 2004; U.S. patent application Ser. No. 10/836,186, filed May 3, 2004; U.S. patent application Ser. No. 10/422,170, filed May 21, 2003; U.S. patent application Ser. No. 10/209,197, filed Aug. 1, 2002, now U.S. Pat. No. 6,731,268; U.S. patent application Ser. No. 09/511,831, filed Feb. 24, 2000, now U.S. Pat. No. 6,466,200; and Russian patent application No. 99122838, filed Nov. 3, 1999, which are all incorporated by reference herein in their entirety.

### BACKGROUND OF THE INVENTION

1. Field of the Invention

The present invention is related to magnetofluidic acceleration sensors.

2. Background Art

Magnetofluidic accelerometers are generally known and described in, e.g., U.S. patent application Ser. No. 10/836,624, filed May 3, 2004, U.S. patent application Ser. No. 10/836,186, filed May 3, 2004, U.S. patent application Ser. No. 10/422,170, filed May 21, 2003, U.S. patent application Ser. No. 10/209,197, filed Aug. 1, 2002 (now U.S. Pat. No. 6,731,268), U.S. patent application Ser. No. 09/511,831, filed Feb. 24, 2000 (now U.S. Pat. No. 6,466,200), and Russian patent application No. 99122838, filed Nov. 3, 1999 that utilize magnetofluidic principles and an inertial body suspended in a magnetic fluid, to measure acceleration. Such an accelerometer often includes a sensor casing (sensor housing, or “vessel”), which is filled with magnetic fluid. An inertial body (inertial object) is suspended in the magnetic fluid. The accelerometer usually includes a number of drive coils (power coils) generating a magnetic field in the magnetic fluid, and a number of measuring coils to detect changes in the magnetic field due to relative motion of the inertial body.

When the power coils are energized and generate a magnetic field, the magnetic fluid starts attempts to position itself as close to the power coils as possible. This, in effect, results in suspending the inertial body in the approximate geometric center of the housing. When a force is applied to the accelerometer (or to whatever device the accelerometer is mounted on), so as to cause angular or linear acceleration, the inertial body attempts to remain in place. The inertial body therefore “presses” against the magnetic fluid, disturbing it and changing the distribution of the magnetic fields inside the magnetic fluid. This change in the magnetic field distribution is sensed by the measuring coils, and is then converted electronically to values of linear and angular acceleration. Knowing linear and angular acceleration, it is then possible, through straightforward mathematical operations, to calculate linear and angular velocity, and, if necessary, linear and angular position. Phrased another way, the accelerometer provides information about six degrees of freedom—three linear degrees of freedom (x, y, z), and three angular (or rotational) degrees of freedom (angular acceleration ω′ₓ, ψ′_{y}, ψ′_{z} about the axes x, y, z).

Sensor stability is an important parameter, since a change in sensor characteristics over time degrades sensor performance. One source of instability is the effect of the magnetic fluid on the drive magnets, and the effect of strong magnetic fields on the magnetic fluid itself. Accordingly, there is a need in the art for an accelerometer with a stable performance over time.

### BRIEF SUMMARY OF THE INVENTION

The present invention relates to a magnetofluidic accelerometer with non-magnetic film on drive magnets that substantially obviates one or more of the issues associated with known acclerometers.

More particularly, in an exemplary embodiment of the present invention, a sensor includes an inertial body; a plurality of sources of magnetic field located generally surrounding the inertial body; magnetic fluid between the sources and the inertial body; and a non-magnetic coating on surfaces of the sources facing the magnetic fluid. Displacement of the inertial body is indicative of acceleration. The acceleration can include linear acceleration and angular acceleration. The angular acceleration can include three components of acceleration about three orthogonal axes. The sources include permanent magnets, or electromagnets, or both. A plurality of sensing coils detect changes in magnetic field within the magnetic fluid due to the displacement of the inertial body. The non-magnetic coating can also cover the sensing coils. A housing encloses the inertial body and the magnetic fluid. The magnetic fluid can use kerosene, water or oil as the carrier liquid. The magnetic fluid is a colloidal suspension. The non-magnetic coating can use Teflon (tetrofluoroethylene), PET (polyethyleneteraphthalate), a polyimide or a resin.

In another aspect, a sensor includes a magnetic fluid; an inertial body surrounded by the magnetic fluid; a plurality of magnets positioned around the inertial body; and a non-magnetic coating on surfaces of the magnets facing the magnetic fluid. Displacement of the inertial body relative to the magnetic fluid is indicative of acceleration.

In another aspect, an accelerometer includes a magnetic fluid; an inertial body in contact with the magnetic fluid; a plurality of magnets positioned around the inertial body; and a plurality of non-magnetic caps coupled to the magnets, each non-magnetic cap separating its corresponding magnet and the magnetic fluid.

In another aspect, a sensor includes a plurality of magnets, each magnet mounted in a casing; a magnetic fluid in contact with the casings; a non-magnetic coating on surfaces of the magnets facing the magnetic fluid; and an inertial body surrounded by the magnetic fluid. Displacement of the inertial body is indicative of acceleration.

In another aspect, an accelerometer includes a housing; a magnetic fluid within the housing; a plurality of magnets mounted on the housing; and a plurality of non-magnetic caps coupled to the magnets, each non-magnetic cap separating its corresponding magnet and the magnetic fluid.

In another aspect, a sensor includes a housing; a magnetic fluid within the housing; a plurality of magnets mounted on the housing; a plurality of sensing coils positioned to sense changes in magnetic fluid behavior; and a non-magnetic coating on surfaces of the magnets and the sensing coils facing the magnetic fluid.

Additional features and advantages of the invention will be set forth in the description that follows, and in part will be apparent from the description, or may be learned by practice of the invention. The advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE FIGURES

The accompanying drawings, which are included to provide a further understanding of the invention and are incorporated in and constitute a part of this specification, illustrate embodiments of the invention and together with the description serve to explain the principles of the invention. In the drawings:

FIG. 1 illustrates an isometric three-dimensional view of an assembled magneto fluidic acceleration sensor of the present invention.

FIG. 2 illustrates a side view of the sensor with one of the drive magnet assemblies removed.

FIG. 3 illustrates a partial cutaway view showing the arrangements of the drive magnet coils and the sensing coils.

FIG. 4 illustrates an exploded side view of the sensor.

FIG. 5 illustrates a three-dimensional isometric view of the sensor of FIG. 4, but viewed from a different angle.

FIGS. 6-8 illustrate alternative isometric views of the drive magnet assemblies, particularly the portions facing the magnetic fluid.

FIGS. 9-10 show two views of a non-magnetic film applied to the portions of the drive magnet assemblies facing the magnetic fluid.

FIG. 11 illustrates non-magnetic caps mounted on the portions of the drive magnet assemblies facing the magnetic fluid.

FIG. 12 shows the distribution of magnetic field intensity in the magnetic fluid at a surface of the drive magnets.

FIG. 13 shows the magnetic field distribution in the magnetic fluid with the non-magnetic film applied to the surface of the drive magnet.

### DETAILED DESCRIPTION OF THE INVENTION

Reference will now be made in detail to embodiments of the present invention, examples of which are illustrated in the accompanying drawings.

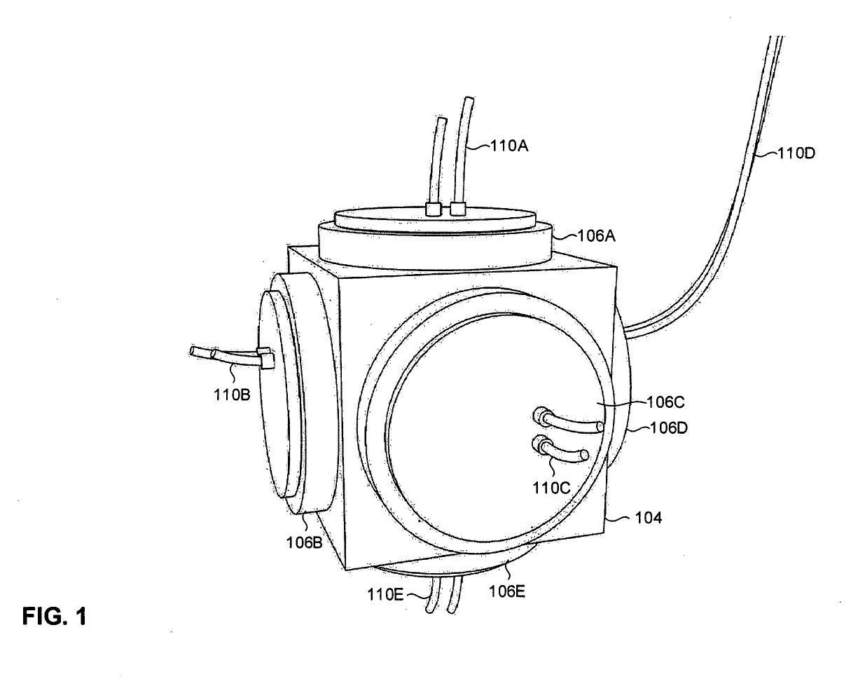

FIGS. 1-5 illustrate an exemplary embodiment of a magnetofluidic acceleration sensor of the present invention. The general principles of operation of the magnetofluidic sensor are described in U.S. Pat. No. 6,466,200, which is incorporated herein by reference. The sensor's behavior is generally described by a set of non-linear partial differential equations, see U.S. Provisional Patent Application No. 60/614,415, to which this application claims priority.

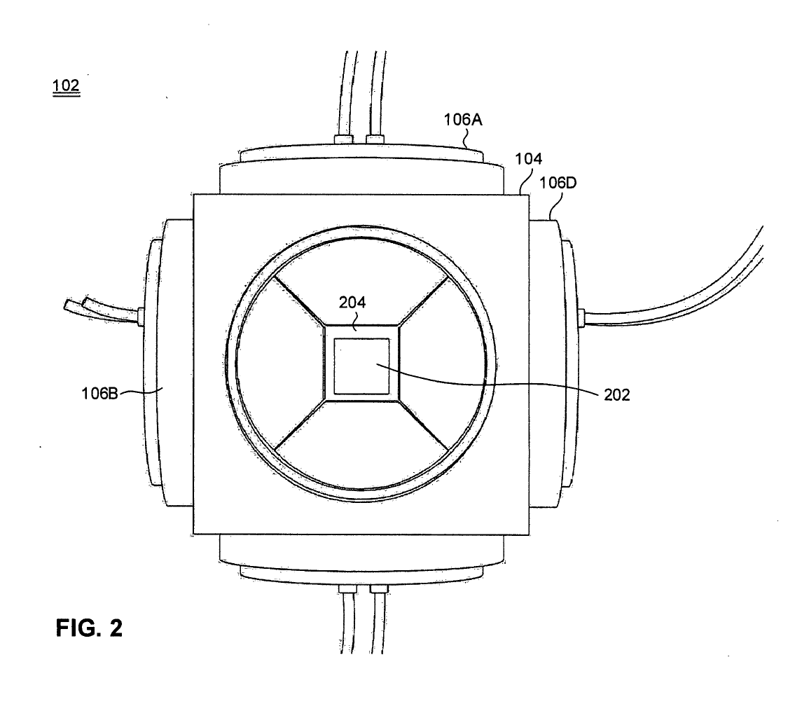

In particular, FIG. 1 illustrates an isometric three-dimensional view of an assembled acceleration sensor. FIG. 2 illustrates a side view of the acceleration sensor with one of the drive magnet casings removed. Note the inertial body in the center.

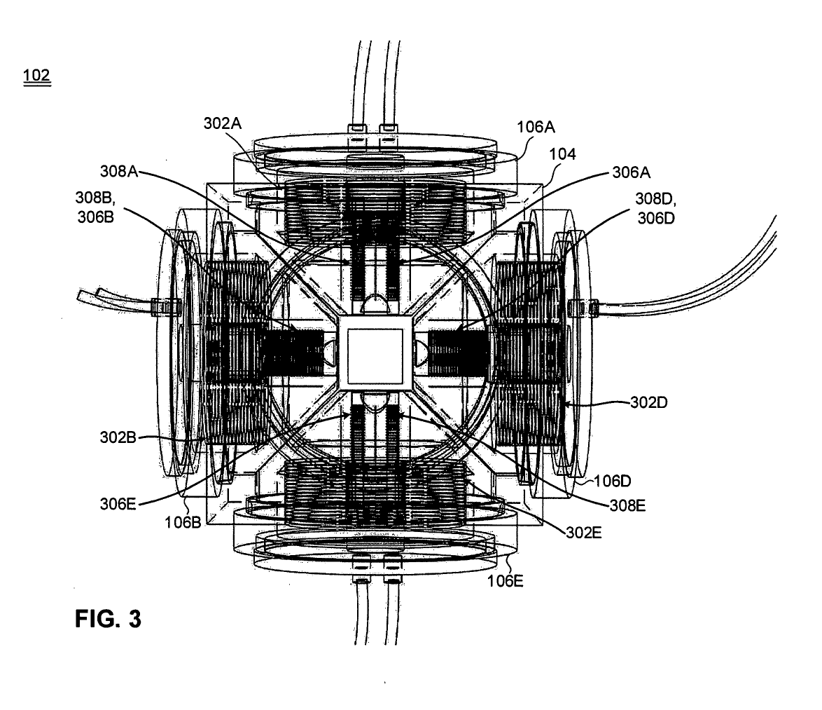

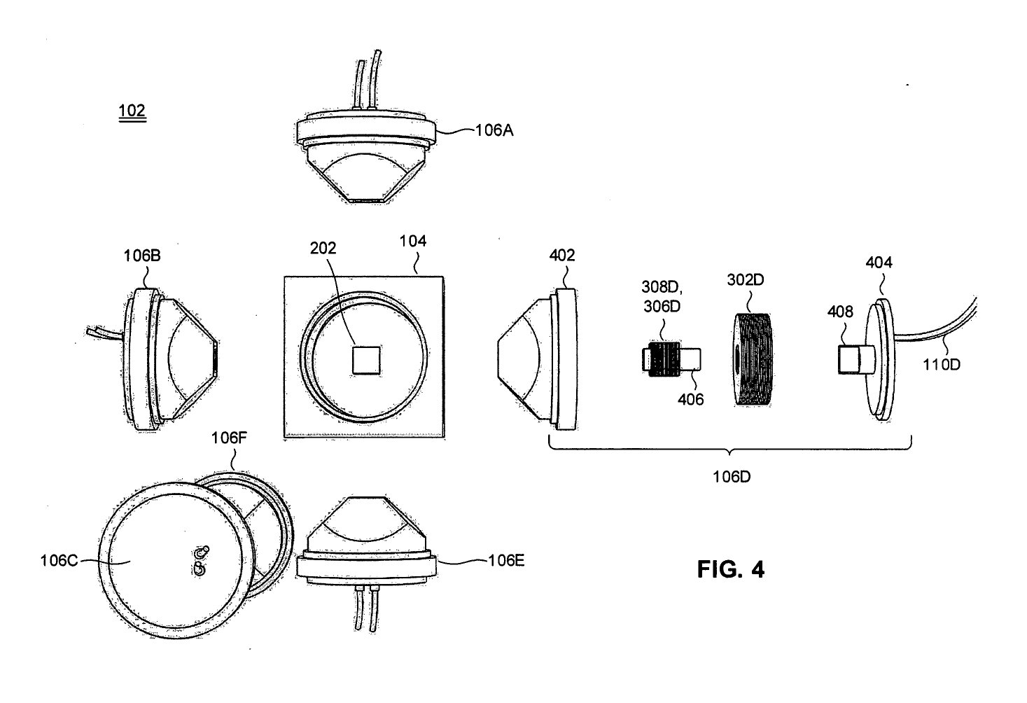

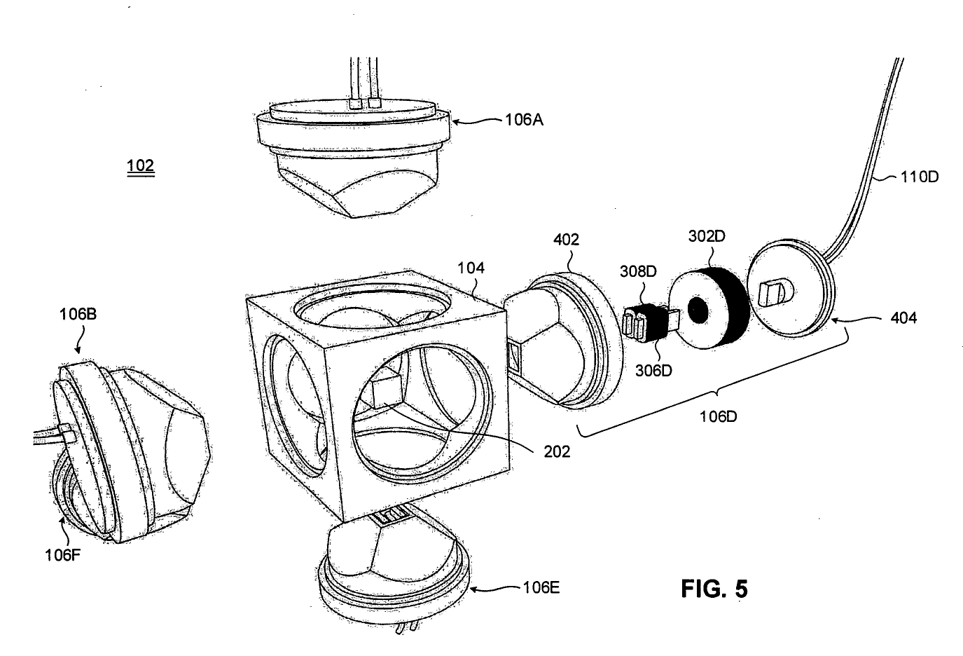

FIG. 3 illustrates a partial cutaway view showing the arrangements of the drive magnet coils and the sensing coils. FIG. 4 illustrates an exploded side view of the sensor, showing the housing, magnetic fluid inside the housing, and the inertial body surrounded by the magnetic fluid. FIG. 5 illustrates a three-dimensional isometric view of what is shown in FIG. 4, but viewed from a different angle.

Further with reference to FIG. 1, the accelerometer 102, shown in FIG. 1 in assembled form, includes a housing 104, and a number of drive magnet assemblies 106A-106E, each of which is connected to a power source using corresponding wires 110A-110E. Note that in this view, only five drive magnet assemblies 106 are shown, but see FIG. 3, where a sixth drive magnet assembly (designated 106F) is also illustrated.

FIG. 2 illustrates the sensor 102 of FIG. 1, with one of the drive magnet assemblies removed. With the drive magnet assembly 106C removed, an inertial body 202 is visible in an approximate geometric center of the housing 104. The magnetic fluid 204 fills the remainder of the available volume within the housing. Note that the magnetic fluid itself is not actually drawn in the figure for clarity, although most such fluids are black in color and have an “oily” feel to them.

FIG. 3 illustrates a partial cutaway view, showing the sensor 102. Only some of the components are labeled in FIG. 3 for clarity. Shown in FIG. 3 are four drive coils (or drive magnets) 302A, 302B, 302E and 302D, collectively referred to as drive magnets 302 (the remaining two drive magnets are not shown in this figure). The drive magnets 302 are also sometimes referred to as suspension magnets, power magnets, or suspension coils (if electromagnets are used).

In one embodiment, each such drive magnet assembly 106 has two sensing coils, designated by 306 and 308 (in FIG. 3, 306A, 308A, 306B, 308B, 306E, 308E, 306E, 308E). The sensing coils 306, 308 are also sometimes referred to as “sensing magnets”, or “measuring coils.” Note further that in order to measure both linear and angular acceleration, two sensing coils per side of the “cube” are necessary. If only a single sensing coil were to be positioned in a center of each side of the “cube,” measuring angular acceleration would be impossible. As a less preferred alternative, it is possible to use only one sensing coil per side of the cube, but to displace it off center. However, the mathematical analysis becomes considerably more complex in this case.

FIGS. 4 and 5 illustrate “exploded” views of the sensor 102, showing the same structure from two different angles. In particular, shown in FIGS. 4 and 5 is an exploded view of one of the drive magnet assembly 106D. As shown in the figures, the drive magnet assembly 106D includes a casing 402, a rear cap 404, the drive coil 302D, two sensing coils 306D and 308D, magnet cores 406 (one for each sensing coil 306D and 308D), and a drive magnet core 408. In an alternative embodiment, the cores 406 and 408 can be manufactured as a single common piece (in essence, as a single “transformer core”).

In this embodiment, the sensing coils 306D and 308D are located inside the drive coil 302D, and the rear cap 404 holds the drive coil 302D and the sensing coils 306D and 308D in place in the drive coil assembly 106D.

The drive magnets 302 are used to keep the inertial body 202 suspended in an approximate geometric center of the housing 104. The sensing coils 306, 308 measure the changes in the magnetic flux within the housing 104. The magnetic fluid 204 attempts to flow to locations where the magnetic field is strongest. This results in a repulsive force against the inertial body 202, which is usually either non-magnetic, or partly magnetic (i.e., less magnetic than the magnetic fluid 204).

The magnetic fluid 203 is highly magnetic, and is attracted to the drive magnets 302. Therefore, by trying to be as close to the drive magnets 302 as possible, the magnetic fluid in effect “pushes out,” or repels, the inertial body 202 away from the drive magnets 302. In the case where all the drive magnets 302 are substantially identical, or where all the drive magnets 302 exert a substantially identical force, and the drive magnets 302 are arranged symmetrically about the inertial body 202, the inertial body 202 will tend to be in the geometric center of the housing 104. This effect may be thought of as a repulsive magnetic effect (even though, in reality, the inertial body 202 is not affected by the drive magnets 302 directly, but indirectly, through the magnetic fluid 204).

One example of the magnetic fluid 204 is kerosene with iron oxide (Fe₃O₄) particles dissolved in the kerosene. The magnetic fluid 204 is a colloidal suspension. Typical diameter of the Fe₃O₄ particles is on the order of 10-20 nanometers (or smaller). The Fe₃O₄ particles are generally spherical in shape, and act as the magnetic dipoles when the magnetic field is applied.

In another embodiment, the magnetic fluid 204 may be a two-phase system that possesses both flowability and high sensitivity to an applied magnetic field. The particle size of the solid phase of the mixture in one embodiment may be on the order of 1×10⁻⁹ meters, up to a few tens of nanometers. One type of suitable magnetic fluid 204 is a low viscosity dispersion of magnetite or loadstone in kerosene, having a density between about 1.1 and about 1.5 grams/cubic centimeter. The kerosene dispersion has an effective viscosity between about 0.005 and about 0.1 PAs and has a magnetizability under a 250 kA/m magnetic field between about 30 and about 50 kA/m. Another suitable magnetic fluid 204 is a low viscosity dispersion of magnetite in liquid organic silicone having a density between about 1.1 and about 1.5 grams/cubic centimeter. The silicon dispersion has an effective viscosity below about 0.7 PAs and has a magnetizability under a 250 kA/m magnetic field of about 25 kA/m. Further, a magnetoreactive suspension of dispersed ferromagnetic matter in liquid organic silicone may serve as a suitable magnetic fluid 204. The magnetoreactive suspension has a density between about 3.4 and about 4.0 grams/cubic centimeters, a friction of factor of about 0.1 to about 0.2, and a wear rate between about 2×10⁻⁷ and about 8×10⁻⁷.

More generally, the magnetic fluid 204 can use other ferromagnetic metals, such as cobalt, gadolinium, nickel, dysprosium and iron, their oxides, e.g., Fe₃O₄, FeO₂, Fe₂O₃, as well as such magnetic compounds as manganese zinc ferrite (ZnₓMn₁₋ₓFe₂O₄), cobalt ferrites, or other ferromagnetic alloys, oxides and ferrites. Also, water or oil can be used as the base liquid, in addition to kerosene.

Because the intensity of the magnetic field is highest at the surface of the drive magnets 302, the magnetic fluid 204 tends to concentrate there. Also, the magnetic dipoles within the magnetic fluid 204 tend to have a greater concentration where the magnetic field has the highest intensity. It is also desirable to have a uniform distribution of the magnetic dipoles throughout the magnetic fluid 204. It should also be noted that magnetic fluid can corrode the windings of the drive magnets 302 and the sensing coils 308, 306.

To address these problems, the drive magnets 302 can be coated with a non-magnetic film, or coating, in order to improve performance. The addition of a non-magnetic film on the surface of the drive magnets 302 facing the magnetic fluid 204 creates a space between the magnetic fluid 204 and the drive magnets 302, improving uniformity of the magnetic fluid 204. Also, there is less chance of leakage of the magnetic fluid 204 from the housing 104 and less chance of corrosion of winding insulation of the drive magnets 302 due to the magnetic fluid 204.

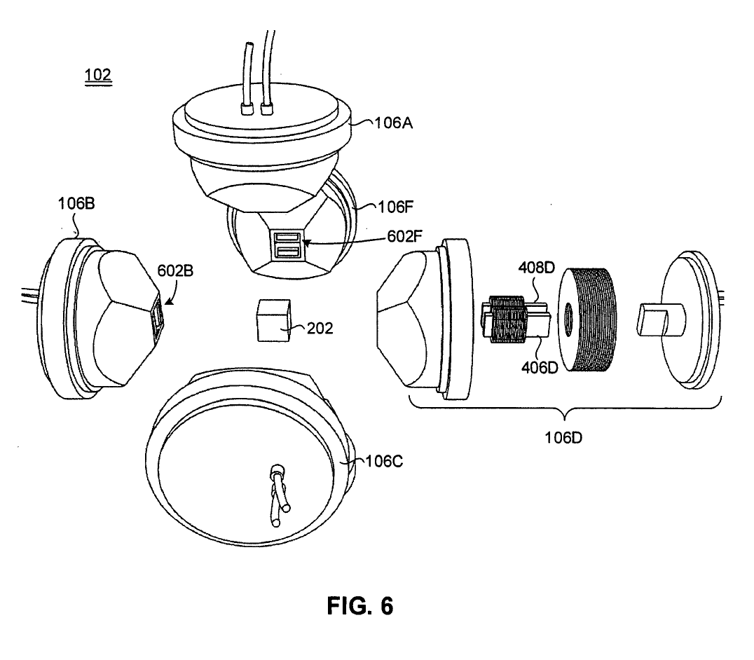

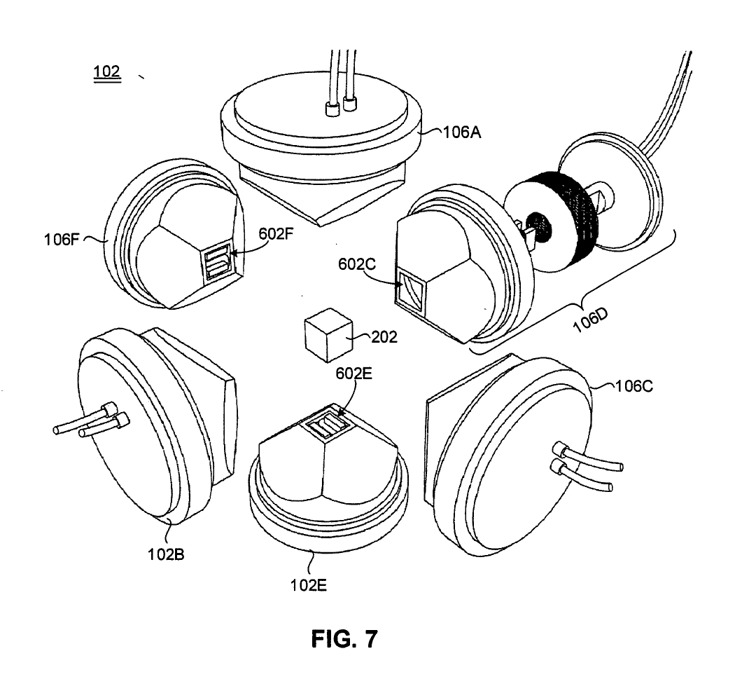

FIGS. 6 and 7 illustrate additional isometric, three-dimensional views of the sensor 102, and are particularly designed to illustrate apertures through which the magnetic fluid 204 can come in contact with the windings of the drive coils 302 and the sensing coils 308, 306. In FIGS. 6 and 7, the housing 104 is not shown, for clarity. Apertures 602F and 602B are visible in FIG. 6, and apertures 602F, 602E, and 602C are visible in FIG. 7, which shows a view from a different angle. Also, for example, in FIG. 7, it is possible to see the forward portions of the sensing coils 308, 306 (unlabeled in this figure), and the forward portions of the sensing coil cores 406, 408 (see also elements 406D and 408D in FIG. 6). Generally, the forward portion of the sensing coil cores 406, 408 is approximately flush with the forward-most face of the assembly 106. This brings the sensing coil cores 406, 408 closest to the magnetic fluid 204, enabling maximum sensitivity.

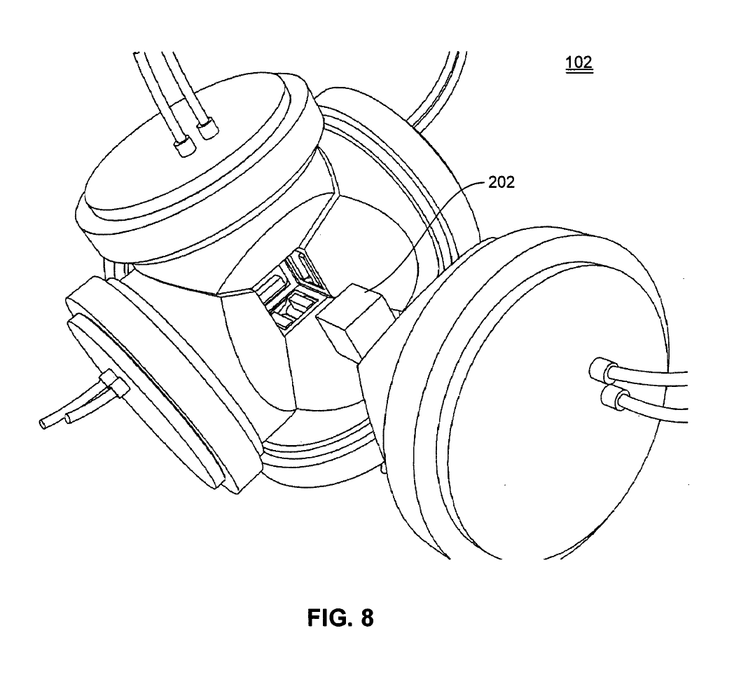

FIG. 8 illustrates another view of the sensor 102, also with the housing 104 not shown. In this figure, with one of the assemblies 106 removed, and the inertial body 202 also moved out of the way, the apertures 602 (unlabeled in this figure) and the sensing coils and sensing coil cores (also unlabeled in this figure) are also visible.

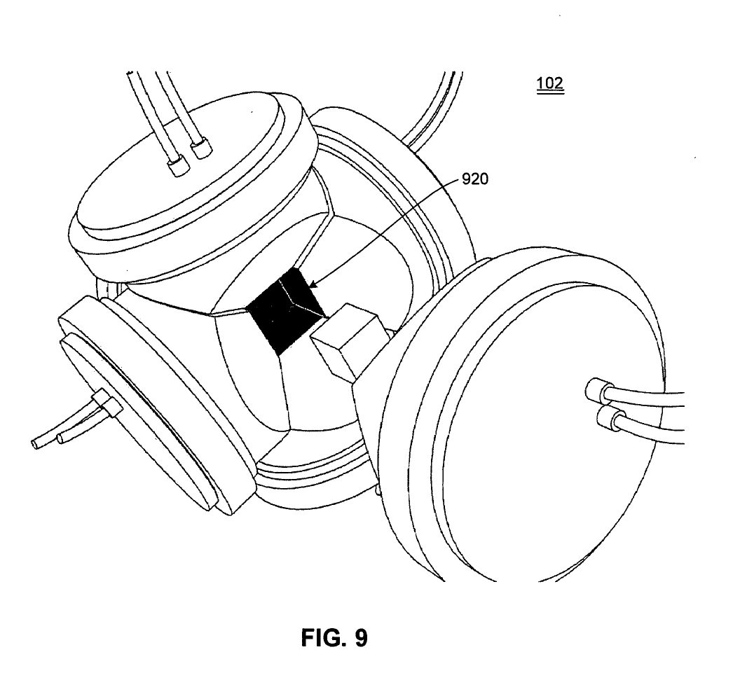

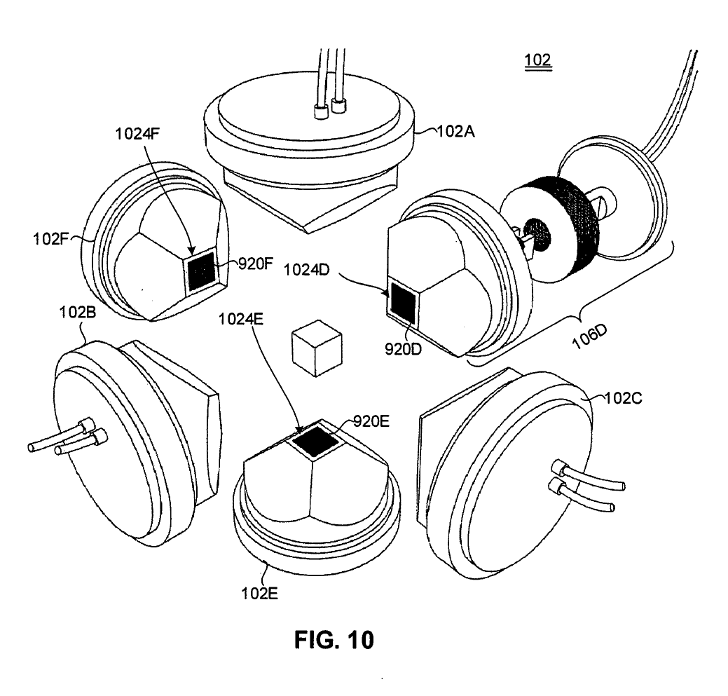

FIGS. 9 and 10 illustrate how a non-magnetic film can be applied to the sensor 102. Essentially, FIG. 9 is a similar view to FIG. 8, with element 920 denoting the film. The film can be formed as a “flat surface,” or as an object that also extends into the aperture.

FIG. 10 illustrates a view similar to FIG. 7, with the individual films shown. In particular, visible in the view of FIG. 10 are the non-magnetic films 920D, 920E, and 920F. In this case, for example, the films can be positioned inside the apertures 602, leaving outer annular portion 1024 (see 1024F, 1024D, 1024E in FIG. 10). In this case, the non-magnetic film 920 would be flush with the surface 1024F, although this need not necessarily be the case.

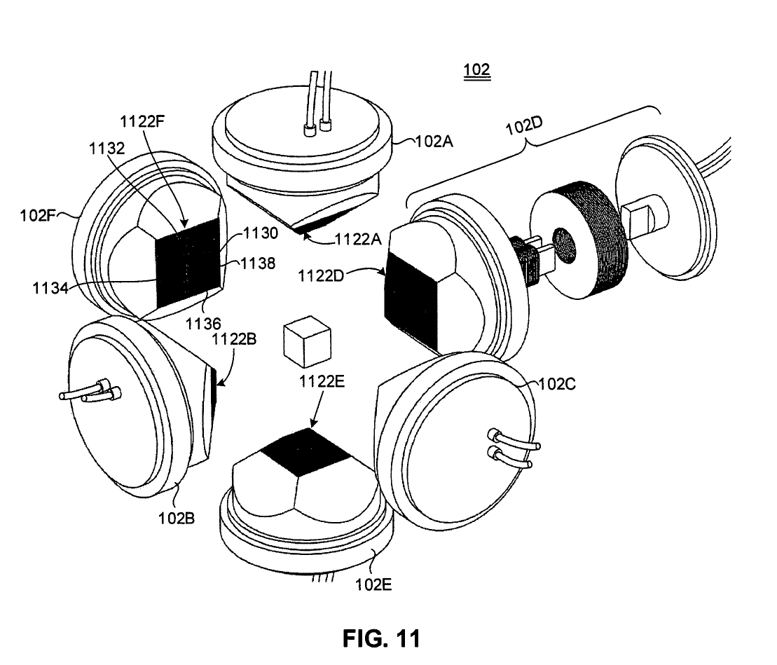

FIG. 11 illustrates an alternative embodiment of a non-magnetic film, which can also be manufactured as a discrete component in the form of a plug, or a cap, and mounted onto the forward surfaces of the assemblies 106. In particular, FIG. 11 illustrates an isometric view of the sensor 102, with the housing 104 not shown, and with the non-magnetic caps 1122A, 1122B, 1122D, 1122E, and 1122F. In this case, the non-magnetic cap for the assembly 102C is not visible in this figure. Each non-magnetic cap can have a forward surface 1130 (see element 1122F), and side surfaces 1132, 1134, 1136 and 1138. Note that, for clarity, only element 1122F has the labels shown in FIG. 11. The other non-magnetic caps 1122 are structured similarly. The caps 1122 can be attached to the assemblies 106, for example, using epoxy, glue, or other means known in the art.

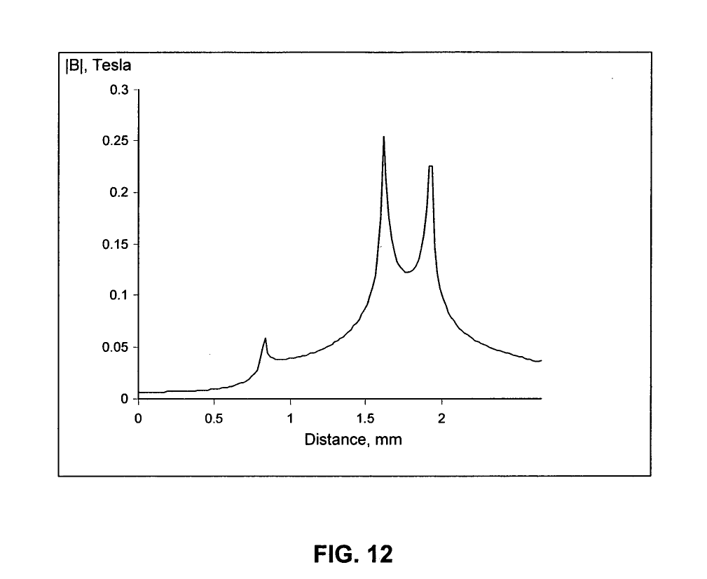

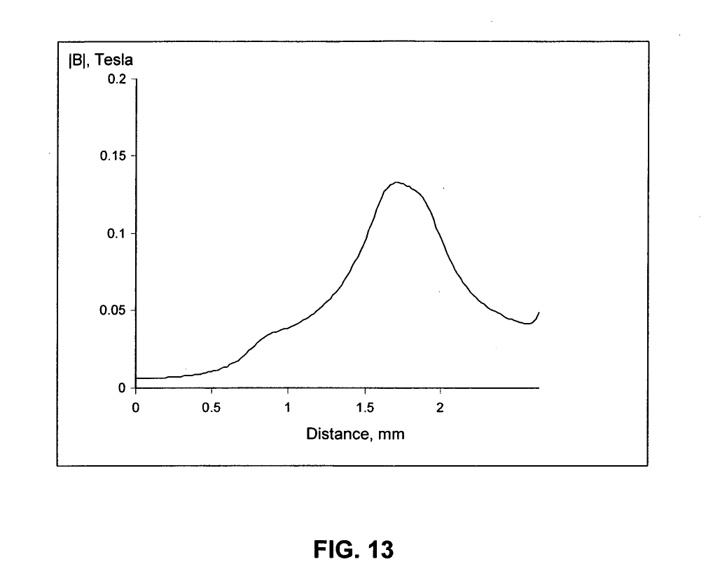

FIG. 12 shows the distribution of magnetic field intensity in the magnetic fluid 204 at the surface of the drive magnets 302 without the use of a non-magnetic film. FIG. 13 shows the magnetic field distribution in the magnetic fluid 204 with the non-magnetic film applied to the surface of the drive magnet 302. As can be seen from these figures, the presence of a non-magnetic film that displaces the magnetic fluid 204 has a beneficial effect, with the magnetic field intensity being more evenly distributed, without the sharp peaks that can result in magnetic dipole aggregation or clumping (see FIG. 13).

Generally, such a non-magnetic film should be either entirely non-magnetic or at most weakly magnetic. Many materials can be used for the non-magnetic film, such as polymers and as polyimides. Other examples of materials include Teflon (tetrofluoroethylene, or PTFE), polyethyleneteraphthalate (PET or Dacron™), or resins, such as fluorinated ethylene-propylene (FEP) resins. Preferably, the non-magnetic film should be mechanically stable, chemically inert relative to the surrounding materials, and have a minimal coefficient of thermal expansion. Alternatively, any such thermal expansion should preferably compensate for (or be matched to) thermal expansion of other components of the sensor 102. Preferably, the non-magnetic film should have a low dielectric dissipation angle.

The non-magnetic film can be deposited, placed, or otherwise formed on the surface of the drive magnet 302 facing the magnetic fluid 204. Its thickness can be anywhere from a few nanometers to on the order of a millimeter, although a thickness of a few microns to a few tens of (or possibly a few hundred) microns is more typical. The non-magnetic film should preferably not react with the magnetic fluid 204 in any way, since corrosion of the non-magnetic film will lead to a change in the properties of the magnetic fluid 204 and, therefore, to a degradation of the characteristics of the sensor 102.

The addition of the non-magnetic film displaces the magnetic fluid 204 from the region of the highest magnetic field intensity. This improves the properties of the magnetic fluid 204, and reduces the possibility of agglomeration, or clumping, of the dipoles within the magnetic fluid 204. This occurs because the magnetic field intensity is inversely proportional to the distance from the drive magnet 302. The addition of the non-magnetic film improves stability of sensor characteristics. Additionally, it provides protection of the drive magnet from the magnetic fluid 204 penetrating into the drive magnets 302. This improves reliability of the sensor 102, since it eliminates the possibility of the windings of the drive magnets 302 being corroded by the magnetic fluid 204, and reduces the possibility of magnetic fluid leakage.

Having thus described an embodiment of the invention, it should be apparent to those skilled in the art that certain advantages of the described method and apparatus have been achieved. It should also be appreciated that various modifications, adaptations, and alternative embodiments thereof may be made within the scope and spirit of the present invention. The invention is further defined by the following claims.

What is claimed is:

1. A sensor comprising:
an inertial body;
a plurality of sources of magnetic field in proximity to the inertial body;
a fluid between the sources and the inertial body; and
a non-magnetic coating on surfaces of the sources facing the fluid,
wherein displacement of the inertial body is indicative of acceleration.

2. The sensor of claim 1, wherein the acceleration comprises at least one component of linear acceleration.

3. The sensor of claim 1, wherein the acceleration comprises at least one component of angular acceleration.

4. The sensor of claim 3, wherein the angular acceleration comprises three components of acceleration about three orthogonal axes.

5. The sensor of claim 1, wherein the sources include permanent magnets.

6. The sensor of claim 1, wherein the sources include electromagnets.

7. The sensor of claim 1, wherein each source comprises a permanent magnet and an electromagnet.

8. The sensor of claim 1, further comprising a plurality of sensing coils for detecting changes in magnetic field within the fluid due to the displacement of the inertial body, wherein the non-magnetic coating covers the sensing coils.

9. The sensor of claim 1, further comprising a housing enclosing the inertial body and the fluid.

10. The sensor of claim 1, wherein the fluid comprises kerosene.

11. The sensor of claim 1, wherein the fluid is a colloidal suspension.

12. The sensor of claim 1, wherein the non-magnetic coating comprises Teflon (tetrofluoroethylene).

13. The sensor of claim 1, wherein the non-magnetic coating comprises PET (polyethyleneteraphthalate).

14. The sensor of claim 1, wherein the non-magnetic coating comprises a polyimide.

15. The sensor of claim 1, wherein the fluid is a magnetic fluid.

16. The sensor of claim 1, wherein the fluid is a ferrofluid.

17. A sensor comprising:
a plurality of magnets, each magnet mounted in a casing;
a fluid in contact with the casings;
a non-magnetic coating on surfaces of the magnets facing the fluid; and
an inertial body surrounded by the fluid,
wherein displacement of the inertial body is indicative of acceleration.

18. The sensor of claim 17, wherein the acceleration comprises at least one component of linear acceleration.

19. The sensor of claim 17, wherein the acceleration comprises at least one component of angular acceleration.

20. The sensor of claim 17, wherein the angular acceleration comprises three components of acceleration about three orthogonal axes.

21. The sensor of claim 17, wherein the magnets include permanent magnets.

22. The sensor of claim 17, wherein the magnets include electromagnets.

23. The sensor of claim 17, wherein each magnet comprises a permanent magnet and an electromagnet.

24. The sensor of claim 17, further comprising a plurality of sensing coils for detecting changes in magnetic field within the fluid due to the displacement of the inertial body, wherein the non-magnetic coating covers the sensing coils.

25. The sensor of claim 17, further comprising a housing enclosing the inertial body and the fluid.

26. The sensor of claim 17, wherein the non-magnetic coating comprises Teflon (tetrofluoroethylene).

27. The sensor of claim 17, wherein the non-magnetic coating comprises PET (polyethyleneteraphthalate).

28. The sensor of claim 17, wherein the non-magnetic coating comprises a polyimide.

29. The sensor of claim 17, wherein the fluid is a magnetic fluid.

30. The sensor of claim 17, wherein the fluid is a ferrofluid.

31. A sensor comprising:
a magnetic fluid;
an inertial body surrounded by the magnetic fluid;
a plurality of magnets positioned around the inertial body; and
a non-magnetic coating on surfaces of the magnets facing the magnetic fluid,
wherein displacement of the inertial body relative to the magnetic fluid is indicative of acceleration.

32. The sensor of claim 31, further comprising a plurality of sensing coils for detecting changes in magnetic field within the magnetic fluid due to the displacement of the inertial body, wherein the non-magnetic coating covers the sensing coils.

33. The sensor of claim 31, further comprising a housing enclosing the inertial body and the magnetic fluid.

34. The sensor of claim 31, wherein the non-magnetic coating comprises Teflon (tetrofluoroethylene).

35. The sensor of claim 31, wherein the non-magnetic coating comprises PET (polyethyleneteraphthalate).

36. The sensor of claim 31, wherein the non-magnetic coating comprises a polyimide.

37. A sensor comprising:
a housing;
a magnetic fluid within the housing;
a plurality of magnets mounted on the housing;
a plurality of sensing coils positioned to sense changes in magnetic fluid behavior; and
a non-magnetic coating on surfaces of the magnets and the sensing coils facing the magnetic fluid.

38. An accelerometer comprising:
a magnetic fluid;
an inertial body in contact with the magnetic fluid;
a plurality of magnets positioned around the inertial body; and
a plurality of non-magnetic caps coupled to the magnets, each non-magnetic cap separating its corresponding magnet and the magnetic fluid.

39. An accelerometer comprising:
a housing;
a magnetic fluid within the housing;
a plurality of magnets mounted on the housing; and
a plurality of non-magnetic caps coupled to the magnets, each non-magnetic cap separating its corresponding magnet and the magnetic fluid.

40. A sensor comprising:
a housing;
a plurality of drive magnet assemblies mounted on the housing, each drive magnet assembly including a casing, a drive magnet, and a sensing coil;
a magnetic fluid within the housing; and
a non-magnetic coating on surfaces of the casings that are in contact with the magnetic fluid.
